(19) United States
(12) Patent Application Publication
(10) Pub. No.: US 2013/0254704 A1
(43) Pub. Date: Sep. 26, 2013

(54) Multiple Simultaneous Displays on the Same Screen

(71) Applicants: Tao Zho, Shanghai (CN); Brett P. Wang, Shanghai (CN); Chengming Zhao, Shanghai (CN); Wanglei L. Wang, Shanghai (CN); John C. Weast, Portland, OR (US)

(72) Inventors: Tao Zho, Shanghai (CN); Brett P. Wang, Shanghai (CN); Chengming Zhao, Shanghai (CN); Wanglei L. Wang, Shanghai (CN); John C. Weast, Portland, OR (US)

(21) Appl. No.: 13/991,569

(22) PCT Filed: Sep. 12, 2011
(86) PCT No.: PCT/CN2011/001543

§ 371 Date: Jun. 4, 2013

(51) Int. Cl. G06F 3/0481

(52) U.S. Cl. CPC G06F 3/0481
USPC 715/781

(57) ABSTRACT

Multiple applications may display information in distinct regions of the display screen at the same time. Multiple user applications using different rendering technologies can display information simultaneously in distinct regions of the same display screen. In addition, a user interface application or user experience application may use different rendering technology than the user applications. The user application may use any desired rendering technology and still simultaneously display information on the user interface by enabling an off screen mode to be automatically implemented by an agent in the rendering technology.

### BACKGROUND

This relates generally to Consumer Electronics (CE) and, particularly, to displaying information on television displays.

Traditionally, a CE device may include hardware, such as a processor, and a software stack. Generally, the software stack assumes that is the sole user of the underlying hardware, including the display.

Thus, generally, there are no conflicts or issues with respect to displaying different things at the same time because one software stack simply displays information from the underlying hardware without issue.

A rendering application program interface (API) is an interface that calls a rendering engine. Examples of rendering engines include, but are not limited to, DirectFB, OpenGL ES, Clutter, Qt, and GTK. Rendering APIs are the programming interface exported by the engines for developer to utilize the functionality of the engines.

Thus, a variety of different rendering APIs and rendering engines that may be utilized. The term “rendering technology” is used to refer to rendering APIs and/or rendering engines.

If different rendering technologies attempt to display information at one time on a display screen, conflicts would surely result.

### BRIEF DESCRIPTION OF THE DRAWINGS

FIG. 1 is a high level depiction of one embodiment of the present invention;

FIG. 2 is a flow chart for one embodiment of the present invention;

FIG. 3 is a flow chart for another embodiment of the present invention;

FIG. 4 is a flow chart for still another embodiment of the present invention;

FIG. 5 is a depiction of a triple buffer embodiment of the present invention;

FIG. 6 is a flow chart for yet another embodiment of the present invention;

FIG. 7 is a software depiction for one embodiment of the present invention;

FIG. 8 is a flow chart for another embodiment of the present invention; and

FIG. 9 is a hardware depiction for one embodiment.

### DETAILED DESCRIPTION

In accordance with some embodiments, multiple applications may display information in distinct regions of a display screen at the same time. In some embodiments, multiple applications, using different rendering technologies, can display information simultaneously in distinct regions of the same display screen. In some embodiments, translation interfaces translate disparate rendering technologies from user applications to a common format and then back into disparate technologies for display. As a result, different user interface technologies and different user application technologies can work together to promote simultaneous display from different applications at the same time on the same screen.

A multiple application framework (MAF) enables a software framework that supports simultaneous execution of multiple applications. Multiple applications may be displayed on a display screen at the same time.

Two different types of applications may be described herein. A “user application” is any application that may want to display information on a display screen. A “user experience” or “user interface application” is an application which actually writes information originated from one more user applications to the onscreen display. Thus, as an example, in a multi-application framework, multiple applications may be initiated by multiple user applications and their outputs may be displayed by one user experience application on the display screen. The rendering technologies used by the user applications may be different from each other and may be different from the rendering technology used by the user experience application, in some embodiments.

A surface management component, in one embodiment, may be a tree entity that holds scene graphs from various user applications. It may enable multiple applications to execute simultaneously onscreen at the same time. The surface management component hosts all underlying memory surface information, as well as the relationships with the processes that created them in some embodiments.

A scene graph shows the source scenes in a multiple application framework as they originate from user applications and indicates how the source scenes are morphed or transformed to be composited into a multiple application framework displayed at the same time on one display screen using a user interface.

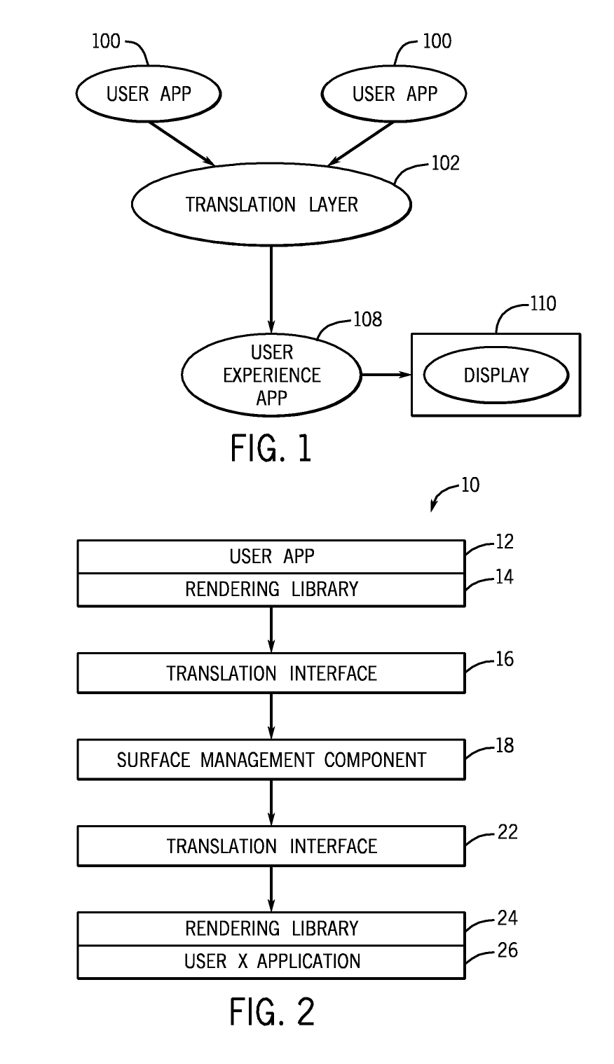

Thus, as shown in FIG. 1, multiple user applications 100 using various rendering technologies may be translated for display on one television display screen 110 using one user experience or user interface application 108.

A translation layer 102 coordinates and resolves conflicts between the different rendering technologies and composites the various user application originated information into one overall combined display. One critical component of the translation layer, in some embodiments, is the surface management component.

Referring to FIG. 2, a more detailed depiction shows an example with only one user application 12, although those skilled in the art will appreciate that many user applications 12 may be utilized in connection with one user experience (userX) application 26. Each user application 12 may have a particular rendering library 14 having rendering technology. In some embodiments, the rendering library may be modified to include a screen off agent. A screen off agent may be added as a patch to conventional rendering libraries to turn off the screen mode and to avoid immediate display on the screen, which would only result in conflicts, as would be the case with the prior practices. In addition, the agent provides the opportunity to translate the information and to coordinate between different user applications and their tasks to display information on the same screen simultaneously.

The translation interface 16 is responsible for translating information provided by each rendering library to a common format.

The surface management agent 18 stores and coordinates between all the drawing surfaces developed by the various user applications 12. Its output is then translated to a form appropriate for use by a particular rendering library 24 used by the then active userX application 26. Thus, the translation interface 22 and the translation interface 26 provide two translations, in some embodiments, to accommodate for the variety of rendering technologies used by user applications and the variety of rendering technologies used by user experience applications.

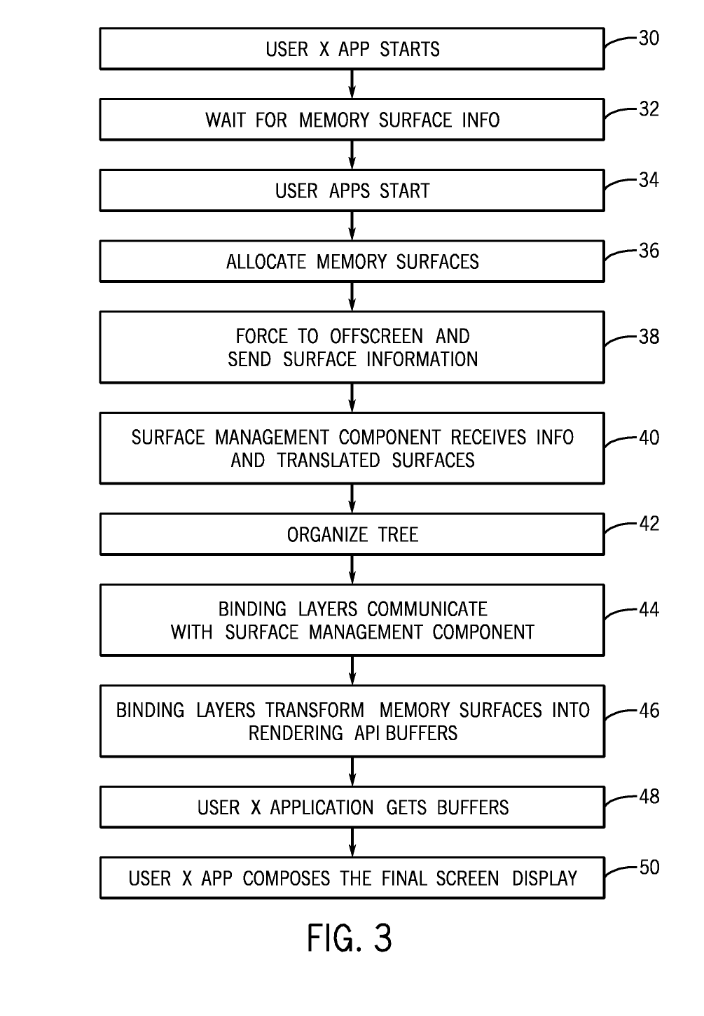

Turning next to FIG. 3, the user experience application starts, as indicated at block 30. Then the user experience application waits for the desired memory surface information, as indicated in block 32. The desired memory surface information may be provided from the translation interface 22 in some embodiments. An example of an interface 22 includes a binding surface. For example, a Clutter binding surface may be translated to a clutter surface.

Then, as indicated in block 34, any user applications that have not already started are started. The user applications allocate specific memory surfaces, as indicated in block 36. Specific memory surfaces may be associated with a particular rendering technology, such as Flash or QT.

Then, a rendering agent inside the rendering library 14 or 24 forces an application to render to off screen memory mode and to send surface information to the surface management component 18, as indicated in block 38. In some embodiments, the rendering agent may be added as a patch, incorporating interrupts into the rendering technology to render to off screen mode. This may be done by inserting a hook into the code inside the rendering library.

The surface management component hosts all underlying memory surface information and the relationships with the processes that created them, as indicated in block 40.

Then, the surface management component receives information of the user application and the translated surfaces and organizes the information in the tree structure, as indicated in blocks 40 and 42.

The binding or translation layers then communicate with the surface management component and transform the memory surface into the rendering API buffers for ease of access and manipulation, as indicated in block 44. The binding layers transform memory surfaces into rendering API buffers (block 48).

The user experience application then gets the buffers of the application's output from the binding layer (block 48). The user experience application composes the final user experience or display, as indicated in block 50.

In some embodiments, hardware implementations may be quicker or more efficient than software implementations. Software implementations may also be implemented without loading surfaces directly into the surface management component, as may be done in hardware embodiments. Instead, in software implementations, messages or communications may be sent to a shared memory, for example, using Internet Protocol communications, to load surfaces.

In some embodiments, multiple applications using different rendering technologies may display multiple applications at the same time on one user interface. This may be done without requiring the users to use one particular type of application, such as Microsoft X-Windows applications.

In some embodiments, the code to implement the multiple application framework may be provided in the bottom layer of a software stack. Also, the code may be implemented by applications or graphics engines, as additional examples.

In accordance with another embodiment, the user experience application may be changed and the system may adapt to the new user interface application. The new user experience application may broadcast its presence after it starts. Then, all running user applications subscribe to the message and are thereby notified of the presence of the new user application. After such notification, the existing user applications send out their surface information to the surface management component to help it rebuild the scene graph. Then the new user experience application uses the information from the surface management component to construct the new user interface.

A broadcast unit inside the user experience application announces the presence of the user application after the user application starts. Likewise, an agent inside the user applications may be notified when the user experience application broadcasts its presence.

In one embodiment, an inter-processor communication (IPC) method may be used by the agent to send the information of the rendering API surfaces to the surface management component. A data structure to hold all of the surface information from the user applications may then be updated upon request. As multiple user interface applications are needed, they may be supported as new user experience applications broadcast their presence and acquire surface information from user applications.

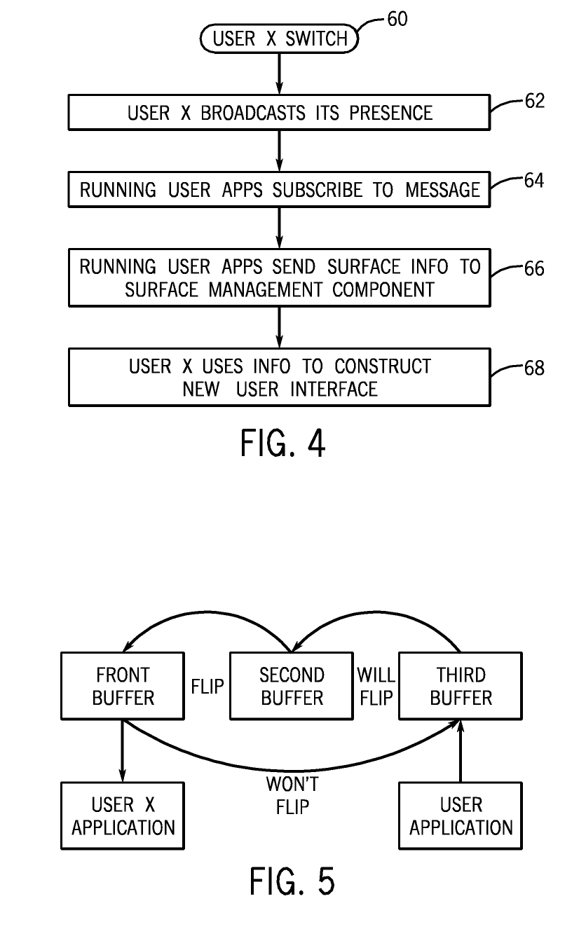

Thus, referring to FIG. 4, a sequence for implementing a user experience application switch 60 begins with the user experience application broadcasting its presence, as indicated in block 62. Any running user applications subscribe to the message, as indicated in block 64. Those running user applications then send their surface information to the surface management component to help it rebuild the scene graph, as indicated in block 66. Finally, the user application uses that information to construct the new user interface, as indicated in block 68.

In accordance with still another embodiment, issues with display blinking may be alleviated. One cause of the blinking display is when buffer flipping occurs. Conventionally, a front buffer and a back buffer are used. User applications write to the back buffer and the front buffer writes to the user experience application. When buffers are flipping (so that the front buffer becomes the back buffer and vice versa), a screen display blink may occur.

Referring to FIG. 5, in some embodiments, triple buffering may be used. The front buffer interfaces with the user experience application. A third (back) buffer is updated by the user applications. An intermediate or second (back) buffer holds a completed frame to be displayed. The front buffer flips with the second (back) buffer and the second (back) buffer flips with the third (back) buffer. The front buffer and third buffer never flip, in one embodiment. Since the second back buffer has an already prepared frame, the user applications may always draw on the third back buffer. In this mode, even without synchronization, when the second back buffer flips to become the front buffer, since it contains a completed frame and the user application is not drawing on it, the output may appear smooth without an image blink.

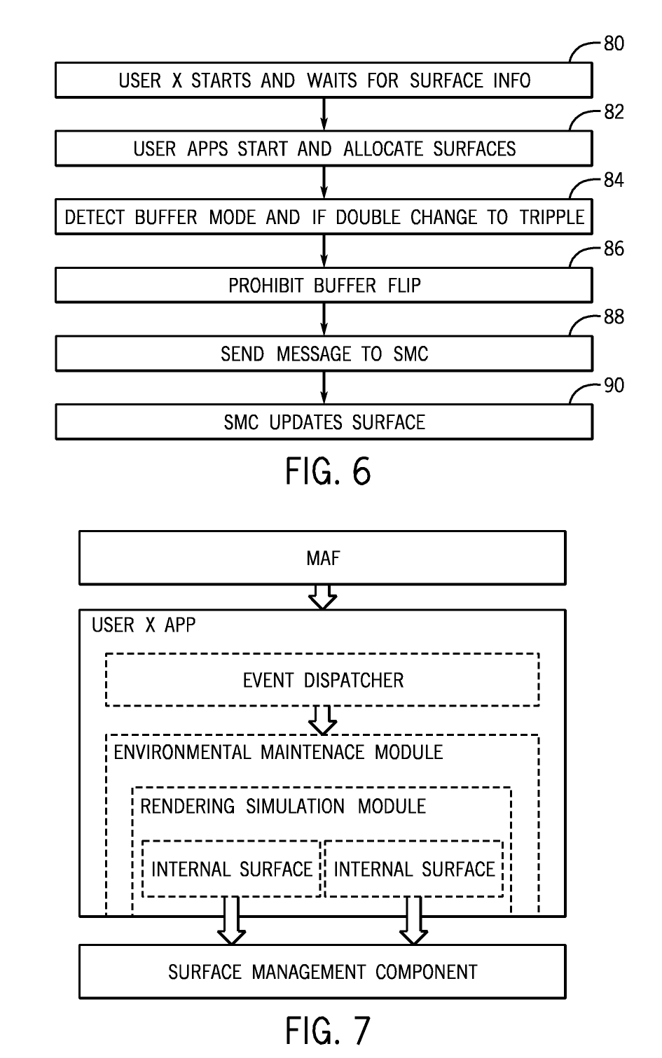

Thus, referring to FIG. 6, in accordance with one embodiment, the user experience application starts and waits for the surface management component information, as indicated in block 80. The user applications start and allocate surfaces from the rendering engine library, as indicated in block 82. Next, the buffer mode is detected. If a double buffer mode is detected, it is automatically switched to a triple buffer mode, as indicated in block 84. Then, a buffer flip between the first and third buffers is prevented, as indicated in block 86. Messages are sent (block 88) to the surface management component about the surface flip and all double buffer applications operate in triple buffer mode. Finally, the surface management component updates the corresponding surfaces, as indicated in block 90.

Referring to FIG. 7, a multiple application framework or MAF may communicate with a user experience application. The user experience application may then communicate with the surface management component memory, as indicated. The user experience application may include an event dispatcher that communicates with the environmental maintenance module, in turn, including a rendering simulation module. The rendering simulation module may include one or more internal surfaces, as indicated.

In some embodiments, each single surface among the surfaces from one or more user applications may communicate with the multiple application framework or surface management component, as if it is the final surface from one single user application.

The surface management component may treat the final surface just as if it were a real user application surface. Alternatively, behind the surface, there may be one simulated real user application. Input events may be dispatched to the single surface, instead of the whole user application that hosts that surface, and each surface may have one registered name, just as if it was one user application. The user experience application handles all the input events of all the surfaces sent to the surface management component, in one embodiment. It also dispatches to the related individual surface, instead of the whole user application holding those surfaces, in one embodiment. Thus, the event dispatcher is responsible for signaling events with respect to individual surfaces, as opposed to applications as a whole.

The environmental maintenance module maintains the objects for each surface, including the stack integrate module method and the client identifier. An application may call the stack integrate module method to register the application name to the surface management component. Further, in some embodiments, every surface in the application may call a stack integrate module method to register the surface name to the surface management component instead of the application name. Also, the application may maintain identifiers, such as a client identifier, for every surface.

User applications running in the multiple application framework send their surface information to the surface management component for access when the application attempts to render the final surface to the screen. The surface management component modifies the graphics library, such as OpenGL ES, DirectFB, and the like. The rendering simulation module simulates the procedure for every surface. Every surface may be generated to an off screen surface instead of onscreen. Then, each surface sends the off screen surface information to the surface management component.

The environmental maintenance module may generate a unique client identifier for every exported surface in the user experience application. The surface registers its name with the surface management component via the stack integrate manager, in some embodiments. The event dispatcher parts as the user input and dispatches events to the correct surface. Then the rendering simulation module handles the rendering process to render the window to an off screen buffer. The rendering simulation module also signals the surface management component to update by way of the client identifier of the related window.

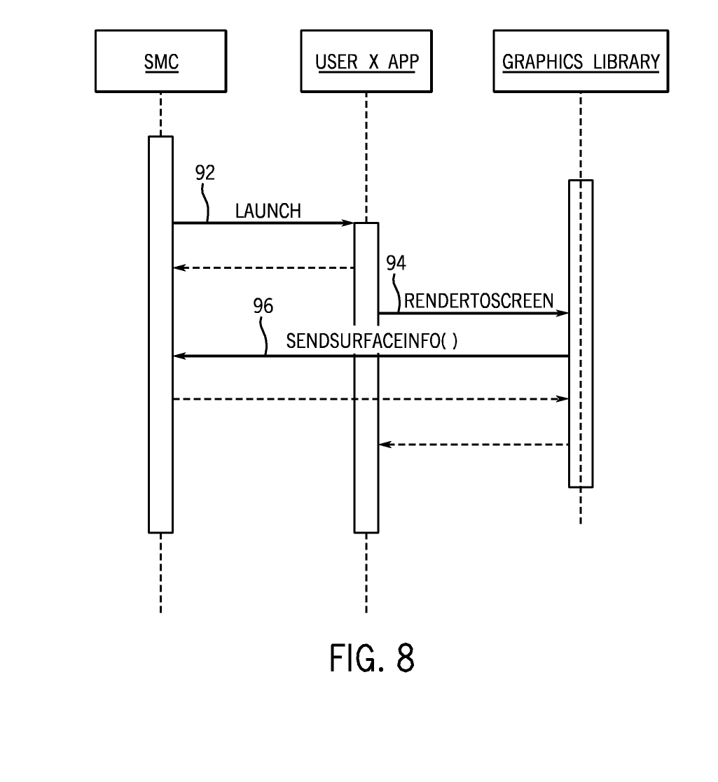

Thus, referring to FIG. 8, the surface management component launches. When it launches, it notifies the user experience application, as indicated at 92. Then the user experience application renders to the graphics library, as indicated at block 94. The graphics library sends the surface information back to the surface management component, as indicated at 96. The process is transparent on the side of the surface management component, which is unaware of the fact that these surfaces are in the same process and yet still manipulates them in the same way as what it did for final surfaces from different user application processes.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

In some embodiments, the architecture depicted in FIGS. 1 and 2 may be implemented in hardware. The hardware may have a variety of architectures. In one embodiment, the hardware may be implemented on a system on a chip. However, the present invention is not limited to embodiments that use a system on a chip.

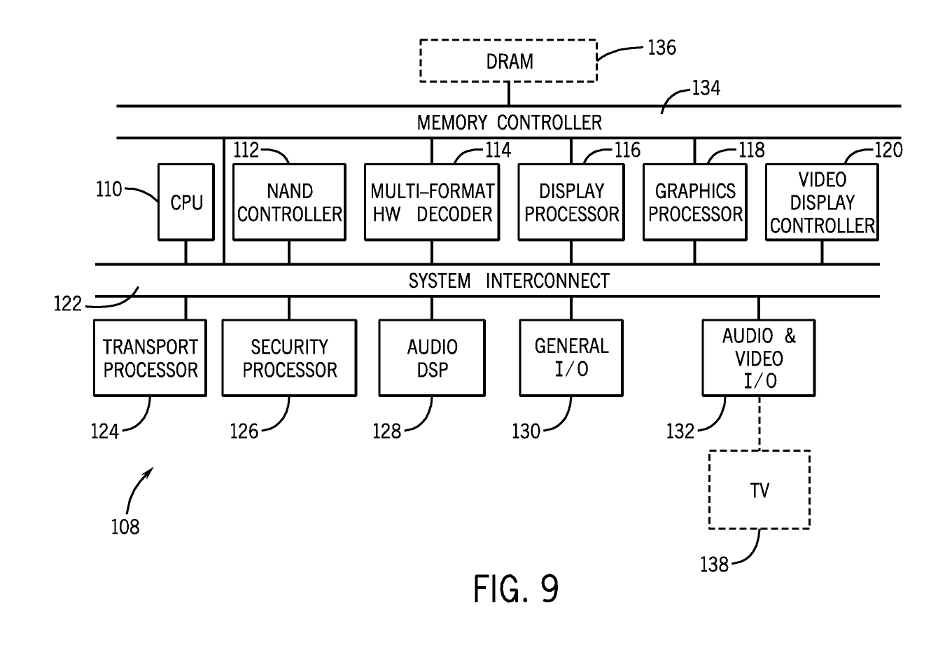

Referring to FIG. 9, a system on a chip embodiment 108 includes a central processing unit 110. The central processing unit 110 may be coupled to a system interconnect 122. Also connected to the system interconnect 122 is a memory controller 112, such as a NAND controller. In one embodiment, the system 108 may boot from NAND memory.

A multi-format hardware decoder 114 may decode a variety of encoding formats for image and video data. A display processor 116 may perform functions on video and still images, including scaling, noise reduction, and motion adaptive de-interlacing, to mention a few examples.

A graphics processor 118 may perform graphics processing for the central processing unit 110, in one embodiment. A video display controller 120 may have a number of universal planes and may provide blending and scaling. In one embodiment, the architectures depicted in FIGS. 1 and 2 may be implemented in the video display controller.

Also connected to the system interconnect 122 is a transport processor 124 that works with a security processor 126 to provide encrypted or decrypted streams.

An audio digital signal processor 128 may have multiple down mix modes and may be responsible for decoding various audio formats. A general input/output device 130 may provide an interface to a variety of different input or output devices, including universal serial bus, I²C bus, and may provide general purpose input/output, as well as interrupts and timing. Finally, the audio and video input/output 132 may receive various audio and video inputs and may provide corresponding formats of audio and video outputs, including a Sony/Philips Digital Interconnect Format (S/PDIF) and High-Definition Multimedia Interface (HDMI), for example.

In some embodiments, an on-chip memory controller 134 may communicate with an off-chip system memory (Dynamic Random Access Memory (DRAM)) 136. In some embodiments, the audio and video I/O 132 may be coupled to a television 138, also off-chip. Thus, in some embodiments, all of the elements depicted in FIG. 9 may be integrated on one integrated circuit, with the exception of the system memory (DRAM) 136 and television display 138.

The system 108 may be a consumer electronics device, such as a television or home entertainment system, a mobile Internet device, a set top box, or a cellular telephone, to mention some examples.

FIGS. 2, 3, 4, 6, and 8 are flow charts. The flow charts depict sequences that may be implemented in hardware, software, and/or firmware in some embodiments. In software embodiments, the sequences may be implemented by instructions stored in a non-transitory computer readable medium. Examples of computer readable media include optical, magnetic, and semiconductor memories or storages, such as the system memory 136.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
enabling a user application using any rendering technology to simultaneously display information on a user interface.

2. The method of claim 1 including enabling different user applications to simultaneously display on the same user interface.

3. The method of claim 1 including enabling user applications using rendering technology different from the rendering technology used by a user interface to render on the same display.

4. The method of claim 1 including disabling on screen mode.

5. The method of claim 1 including translating a rendering technology from a user application.

6. The method of claim 5 including translating rendering technology provided to a user experience application.

7. The method of claim 1 including modifying a rendering library to change a user application's onscreen output to an off screen output.

8. The method of claim 1 including identifying each of a plurality of surfaces from one or more user applications individually and communicating with said surfaces as if said surfaces were the final surface from one single user application.

9-10. (canceled)

11. A method comprising:
rendering multiple applications using different rendering technologies; and
displaying outputs from multiple applications on the same screen display at the same time.

12. The method of claim 11 including modifying a rendering library to change a user application's onscreen output to an off screen output.

13. The method of claim 11 including translating a rendering technology from a user application.

14. The method of claim 13 including translating a rendering technology provided to a user experience application.

15. The method of claim 11 including identifying each of a plurality of surfaces from one or more user applications individually and communicating with said surfaces as if said surfaces were the final surface from one single user application.

16. The method of claim 11 including using a front buffer and at least two back buffers.

17. The method of claim 11 including enabling a user interface to be changed by notifying the user applications of the presence of the new user interface application.

18. A non-transitory computer readable medium storing instructions to enable a processor to use any rendering technology to simultaneously display information on a user interface.

19. The medium of claim 18 further storing instructions to simultaneously display different user applications on the same user interface.

20. The medium of claim 18 further storing instructions to enable user applications to use rendering technology different from the rendering technology used by a user interface to render on the same display.

21. The medium of claim 18 further storing instructions to translate a rendering technology from a user application.

22-26. (canceled)

27. An apparatus comprising:
a processor to enable a user application using any rendering technology to simultaneously display information on a user interface; and
a memory coupled to said processor.

28. The apparatus of claim 27 wherein said processor is part of a system on a chip.

29. The apparatus of claim 27, said processor to enable different user applications to simultaneously display on the same user interface.

30. The apparatus of claim 29 wherein said processor is coupled to a television display.

31. The apparatus of claim 28, said processor to enable user applications using rendering technology different from the rendering technology used by a user interface to render on the same display.

32. The apparatus of claim 28, said processor to translate a rendering technology from a user application.

33. The apparatus of claim 32, said processor to translate rendering technology provided to a user experience application.

34. The apparatus of claim 28, said processor to modify a rendering library to change a user applications onscreen output to off screen output.

35. The apparatus of claim 28, said processor to identify each of a plurality of surfaces from one or more user applications individually and communicate with said surfaces as if said surfaces were the final surface from one single user application.

36. The apparatus of claim 28, said processor to use a front buffer and at least two back buffers.

37. The apparatus of claim 28, said processor to enable a user interface to be changed by notifying the user applications of the presence of a new user interface application.

38-40. (canceled)
